(19) United States
(12) Patent Application Publication
(10) Pub. No.: US 2024/0193436 A1
(43) Pub. Date: Jun. 13, 2024

(54) METHOD FOR PREDICTING USER PERSONALITY USING PRE-OBTAINED PERSONALITY INDICATORS AND TIME-SERIES INFORMATION

(71) Applicant: Korea Electronics Technology Institute, Seongnam-si (KR)

(72) Inventors: Jae Woong YOO, Seongnam-si (KR); Hye Dong JUNG, Seoul (KR); Mi Ra LEE, Hwaseong-si (KR)

(73) Assignee: Korea Electronics Technology Institute, Seongnam-si (KR)

(21) Appl. No.: 18/536,589

(22) Filed: Dec. 12, 2023

(30) Foreign Application Priority Data
Dec. 13, 2022 (KR) 10-2022-0173464
Mar. 21, 2023 (KR) 10-2023-0036767

(51) Int. Cl. G06N 5/02; G06V 40/16; G06V 40/20

(52) U.S. Cl. CPC G06N 5/02; G06V 40/176; G06V 40/20

(57) ABSTRACT

There is provided a user personality prediction method using pre-obtained personality indicators and time-series information. According to an embodiment, a personality prediction method may acquire personality indicators representing personalities of a user, may acquiring external features of the user as time-series data, may train a personality prediction model with correlations between the acquired external features and the personality indicators, and may predict personality indicators of the user from the external features of the user by using the trained personality prediction model. Accordingly, a personality of a user is predicted in real time based on external features extracted in real time, and hence, personality prediction may be performed flexibly in response to a subtle change in AU intensities acquired as time-series data.

### CROSS-REFERENCE TO RELATED APPLICATION(S) AND CLAIM OF PRIORITY

This application is based on and claims priority under 35 U.S.C. § 119 to Korean Patent Application No. 10-2022-0173464, filed on Dec. 13, 2022, and Korean Patent Application No. 10-2023-0036767, filed on Mar. 21, 2023, in the Korean Intellectual Property Office, the disclosure of which is herein incorporated by reference in its entirety.

### BACKGROUND

### Field

The disclosure relates to a user personality prediction method, and more particularly, to a method for predicting a personality of a user by using personality indicators of the user which are identified through a psychology questionnaire, and facial expressions/action characteristics which are constituted by time-series data.

### Description of Related Art

Thanks to the convergence of platforms and development of technologies, user-customized services which understand attributes of humans and suggest technologies most appropriate or suited to environments are enhanced rapidly.

Accordingly, definitions and meanings of computing, interfaces, etc. between a user and a system are extended, and the field of interaction between humans and computers perform an important role in researching ways of enabling users to interact with systems easily and comfortably.

In particular, as hardware capable of storing and utilizing huge amounts of data is rapidly developing, the importance of a task of understanding users' behavior and emotion and predicting by using individual information of users is stressed.

A human personality may be an essential element to understand and predict a user, and may be an index for expressing a human changing every time. Accordingly, there is a need for a solution for predicting a changeable personality of a user which is exhibited in various environments.

Methods for predicting a classified item in psychology as a category (class) through a prediction model (module) has been attempted as a method for predicting a user personality. However, related-art methods do not reflect changing characteristics of users.

### SUMMARY

The disclosure has been developed in order to solve the above-described problems, and an object of the disclosure is to provide, as a solution for reflecting user characteristic changing in real time in predicting a personality, a personality prediction method using personality indicators of a user which are identified through a psychology questionnaire, and characteristics of the user which are constituted by time-series data.

According to an embodiment of the disclosure to achieve the above-described object, a personality prediction method may include: a step of acquiring personality indicators representing personalities of a user; a step of acquiring external features of the user as time-series data; a step of training a personality prediction model with correlations between the acquired external features and the personality indicators; and a step of predicting personality indicators of the user from the external features of the user by using the trained personality prediction model.

The personality indicators may be identified through a survey for the user. The personality indicators may include an indicator representing openness to experience, an indicator representing conscientiousness, an indicator representing extraversion, an indicator representing agreeableness, and an indicator representing neuroticism.

The external features of the user may be AU intensities. The external features of the user may include at least one of facial expressions and actions of the user.

At the step of training, a plurality of external features may change with time, but personality indicators may not change with time. The step of training may include quantifying levels of contribution of each external feature to respective personality indicators.

The step of predicting may include normalizing the external features by using averages of the levels of contribution of the external features to the respective personality indicators, and inputting the normalized external features to the personality prediction model. The step of predicting may be performed in real time.

According to another embodiment of the disclosure, a personality prediction system may include: a first acquisition unit configured to acquire personality indicators representing personalities of a user; a second acquisition unit configured to acquire external features of the user as time-series data; a training unit configured to train a personality prediction model with correlations between the acquired external features and the personality indicators; and a prediction unit configured to predict personality indicators of the user from the external features of the user by using the trained personality prediction model.

According to still another embodiment of the disclosure, a personality prediction method may include: a step of acquiring external features of a user; and a step of predicting personality indicators of the user from the external features of the user by using a personality prediction model, and the personality prediction model may be a model that learns correlations between external features acquired as time-series data and pre-acquired personality indicators.

According to yet another embodiment of the disclosure, a personality prediction system may include: an acquisition unit configured to acquire external features of a user; and a prediction unit configured to predict personality indicators of the user from the external features of the user by using a personality prediction model, and the personality prediction model may be a model that learns correlations between external features acquired as time-series data and pre-acquired personality indicators.

As described above, according to embodiments of the disclosure, a personality of a user may be exactly predicted by using a model that embeds correlations between personality indicator of the user which are identified through a psychology questionnaire, and features of the user which are constituted by time-series data.

According to embodiments of the disclosure, since a personality of a user is predicted in real time based on AU intensities extracted in real time, personality prediction may be performed flexibly in response to a subtle change in AU intensities acquired as time-series data.

In addition, according to embodiments of the disclosure, since a personality is predicted based on AU intensities extracted from an image rather than based on direct analysis of an image, calculation time may be reduced and it is possible to predict a personality in real time.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating a configuration of a real-time personality prediction system according to an embodiment of the disclosure;

FIG. 2 is a view illustrating examples of AU intensities and personality indicators;

FIG. 3 is a view to explain a level of contribution of each AU intensity to personality indicators; and

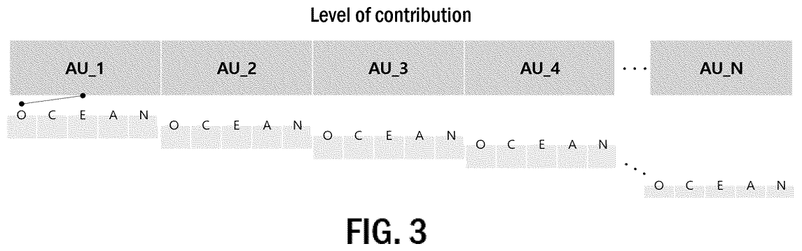

FIG. 4 is a view to explain an AU intensity normalization method.

### DETAILED DESCRIPTION

Hereinafter, the disclosure will be described in more detail with reference to the accompanying drawings.

Embodiments of the disclosure provide a user personality prediction method using pre-obtained personality indicators and time-series information. The disclosure relates to a technology for predicting a personality of a user in real time by using a model that learns correlations between personality indicators of the user which are identified through a psychology questionnaire, and facial expressions/action characteristics which are constituted by time-series data.

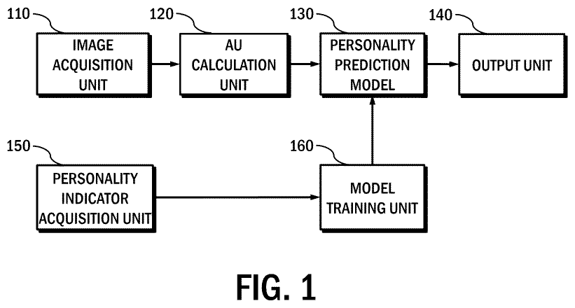

FIG. 1 is a view illustrating a configuration of a real-time personality prediction system according to an embodiment of the disclosure. As shown in FIG. 1, the real-time personality prediction system according to an embodiment may include an image acquisition unit 110, an action unit (AU) calculation unit 120, a personality prediction model 130, an output unit 140, a personal indicator acquisition unit 150, and a model training unit 160.

In the real-time personality prediction system according to an embodiment, a personality of a user may be predicted (inferred) by the personality prediction model 130. Personality prediction is premised on the assumption that the model training unit 160 trains the personality prediction model 130. A process of training the personality prediction model 130 will be described hereinbelow.

The image acquisition unit 110 may be a camera for acquiring an image in which a user appears in real time, or a communication means for receiving a corresponding image. A user image acquired by the image acquisition unit 110 is applied to the AU calculation unit 120.

The AU calculation unit 120 extracts AU intensities of the user from the user image applied from the image acquisition unit 110. An AU refers to a specific motion of a user, and for example, may include “inner brow raise”, “outer brow raise”, “eye widen”, “squint”, “eyes closed”, “lip corner pull”, “lip corner depress”, “lip press”, etc.

An AU intensity refers to an intensity of a corresponding motion. If AU is inner brow raise, an AU intensity refers to a degree of inner brow raise, and, if AU is lip corner depress, an AU intensity refers to a degree of lip corner depress.

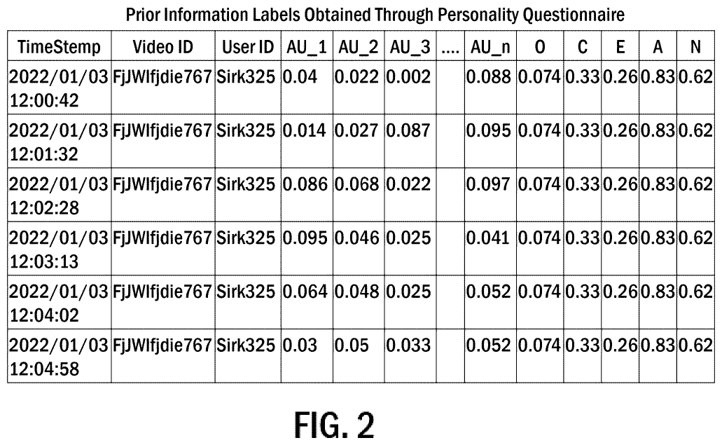

Like the image acquisition unit 110 acquiring an image in real time, the AU calculation unit 120 extracts AU intensities in real time, and thus, the AU intensities are obtained as time-series data. It is illustrated in the center of the table of FIG. 2 that AU_1 intensity, AU_2 intensity, AU_3 intensity, . . . , AU_N intensity are obtained as time-series data.

The personality indicator acquisition unit 150 is a means for acquiring personality indicators indicating a personality of a user. OCEAN (big five factors) may be utilized as personality indicators. Herein, O is an indictor representing openness to experience, C is an indicator representing conscientiousness, E is an indicator representing extraversion, A is an indicator representing agreeableness, and N is an indicator representing neuroticism.

The personality indicators of the user may be identified through a psychology questionnaire for the user, and may be used for training the personality prediction model 130 along with the above-described AU intensities. It is illustrated in the right side of the table of FIG. 2 that O, C, E, A, N indicators which are personality indicators of the user are obtained. As shown in FIG. 2, AU intensities are acquired in real time and thus change with time, but personality indicators are not acquired in real time and do not change with time.

The model training unit 160 is a means for training the personality prediction model 130, and quantifies levels of contribution of each AU intensity to the O, C, E, A, N indicators. Specifically, the model training unit 160 may analyze the table generated as shown in FIG. 2, and may quantify:
1) levels of contribution of AU_1 to O indicator, C indicator, E indicator, A indicator, and N indicator, respectively;
2) levels of contribution of AU_2 to O indicator, C indicator, E indicator, A indicator, and N indicator, respectively;
N) levels of contribution of AU_N to O indicator, C indicator, E indicator, A indicator, and N indicator, respectively.

As described above, the model training unit 160 may analyze correlations between AU intensities and personality indicators, and may embed the result of analyzing in the personality prediction model 130, so that the personality prediction model 130 can utilize the result of analyzing in predicting a personality. A process of predicting a user personality using the personality prediction model 130 will be described hereinbelow.

First, the image acquisition unit 110 acquires an image in which a user appears in real time, and the AU calculation unit 120 extracts AU intensities of the user from the image acquired by the image acquisition unit 110 in real time.

Then, the personality prediction model 130 which is trained by the model training unit 160 predicts (infers) O, C, E, A, N indicators from the extracted AU intensities in real time. The output unit 140 outputs the result of predicting by the personality prediction model 130.

The personality predicted according to real-time AU intensities of the user changes in real time. Real-time changes in the personality of the user may be seen through the output unit 140.

Up to now, a user personality prediction method using pre-obtained personality indicators and time-series information has been described with reference to preferred embodiments.

In the above-described embodiments, a personality of a user may be predicted in real time by using a model that learns correlations between OCEAN indicators which are personality indicator of the user identified through a psychology questionnaire, and an AU which is constituted by time-series data.

Since a personality of a user is predicted in real time based on AU intensities extracted in real time, personality prediction may be performed flexibly in response to a subtle change in AU intensities acquired as time-series data.

In addition, since a personality is predicted based on AU intensities extracted from an image rather than based on direct analysis of an image, calculation time may be reduced and it is possible to predict a personality in real time.

The AU calculation unit 120 may normalize the extracted AU intensities of the user and then may input the normalized AU intensities to the personality prediction model 130. In normalizing AU intensities, levels of contribution of AU intensities to personality indicators may be utilized.

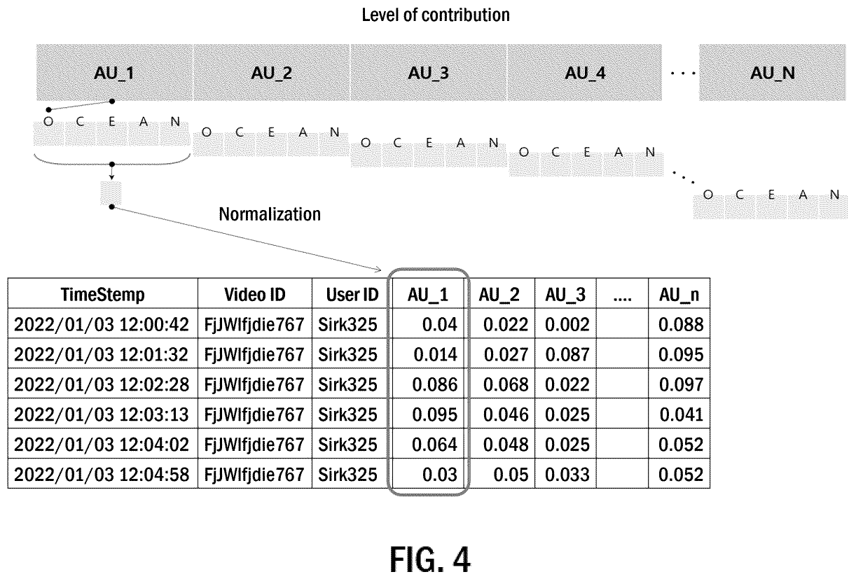

Specifically, as shown in FIG. 4, it is possible to normalize AU intensities by further using an average of levels of contribution of an AU intensity to personality indicators (O, C, E, A, N indicators). For example, normalization may be performed to make an average of normalized AU intensities equal to an average of levels of contribution.

In addition, in the above-described embodiments, characteristics exemplified as AUs relate to facial expressions. However, there is no limit to AUs. For example, the technical concept of the disclosure may be applied when AUs regarding motions of user's body (shoulders, arms, etc.) are applied.

It is possible to give an upper limit value and/or a lower limit value to levels of contribution of an AU intensity to personality indicators (O, C, E, A, N indicators) according to a type of AU. For example, in the case of AU_1, an upper limit value of 0.2 may be given to a level of contribution to O indicator, and a lower limit value of 0.2 may be given to a level of contribution to A indicator.

Furthermore, if an AU intensity is such that an average of levels of contribution to personality indicators (O, C, E, A, N indicators) is less than a threshold value, the AU intensity may be excluded not to be used in predicting (inferring) O, C, E, A, N indicators by the personality prediction model 130, that is, may not be inputted to the personality prediction model 130.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A personality prediction method comprising:
a step of acquiring personality indicators representing personalities of a user;
a step of acquiring external features of the user as time-series data;
a step of training a personality prediction model with correlations between the acquired external features and the personality indicators; and
a step of predicting personality indicators of the user from the external features of the user by using the trained personality prediction model.

2. The personality prediction method of claim 1, wherein the personality indicators are identified through a survey for the user.

3. The personality prediction method of claim 2, wherein the personality indicators comprise an indicator representing openness to experience, an indicator representing conscientiousness, an indicator representing extraversion, an indicator representing agreeableness, and an indicator representing neuroticism.

4. The personality prediction method of claim 2, wherein the external features of the user are AU intensities.

5. The personality prediction method of claim 4, wherein the external features of the user comprise at least one of facial expressions and actions of the user.

6. The personality prediction method of claim 1, wherein, at the step of training, a plurality of external features change with time, but personality indicators do not change with time.

7. The personality prediction method of claim 6, wherein the step of training comprises quantifying levels of contribution of each external feature to respective personality indicators.

8. The personality prediction method of claim 7, wherein the step of predicting comprises normalizing the external features by using averages of the levels of contribution of the external features to the respective personality indicators, and inputting the normalized external features to the personality prediction model.

9. The personality prediction method of claim 1, wherein the step of predicting is performed in real time.

10. A personality prediction system comprising:
a first acquisition unit configured to acquire personality indicators representing personalities of a user;
a second acquisition unit configured to acquire external features of the user as time-series data;
a training unit configured to train a personality prediction model with correlations between the acquired external features and the personality indicators; and
a prediction unit configured to predict personality indicators of the user from the external features of the user by using the trained personality prediction model.

11. A personality prediction method comprising:
a step of acquiring external features of a user; and
a step of predicting personality indicators of the user from the external features of the user by using a personality prediction model,
wherein the personality prediction model is a model that learns correlations between external features acquired as time-series data and pre-acquired personality indicators.
